(19) United States
(12) Patent Application Publication
(10) Pub. No.: US 2015/0030761 A1
(43) Pub. Date: Jan. 29, 2015

(54) APPARATUS AND PROCESS FOR PRODUCING FLUORINATED ORGANOSILICON COMPOUND THIN FILM

(71) Applicant: ASAHI GLASS COMPANY, LIMITED, Chiyoda-ku (JP)

(72) Inventors: Ryosuke KATO, Tokyo (JP); Masao Miyamura, Tokyo (JP); Tamotsu Morimoto, Tokyo (JP)

(73) Assignee: ASAHI GLASS COMPANY, LIMITED, Chiyoda-ku (JP)

(21) Appl. No.: 14/466,223

(22) Filed: Aug. 22, 2014

Related U.S. Application Data
(63) Continuation of application No. PCT/JP2013/054222, filed on Feb. 20, 2013.

(30) Foreign Application Priority Data
Feb. 23, 2012 (JP) 2012-037970

(51) Int. Cl. C09D 5/16; B05D 1/02; B05D 1/00

(52) U.S. Cl. CPC C09D 5/1637; B05D 1/60; B05D 1/02
USPC 427/8; 118/729; 118/712; 427/255.393

(57) ABSTRACT

To provide an apparatus and process capable of continuously forming a fluorinated organosilicon compound thin film having high durability while a substrate is transported.

An apparatus for producing a fluorinated organosilicon compound thin film, which comprises a chamber, a heating container for heating a deposition material, a plurality of nozzles for supplying the deposition material to a substrate, provided in the chamber and connected to the heating container, and a substrate transport mechanism for transporting the substrate, wherein the plurality of nozzles are arranged in a line so that they cross the direction of transport of the substrate, and a fluorinated organosilicon compound as the deposition material is one subjected to a solvent removal treatment or one not diluted; and a process for producing a fluorinated organosilicon compound thin film, which comprises heating a fluorinated organosilicon compound subjected to a solvent removal treatment or not diluted, in a heating container, supplying the deposition material from a plurality of nozzles arranged in a line so that they cross the direction of transport of the substrate, provided in a chamber and connected to the heating container, and forming a thin film on a surface of the substrate on which a thin film is to be formed, while the substrate is transported.

### TECHNICAL FIELD

The present invention relates to an apparatus and process for producing a fluorinated organosilicon compound thin film.

### BACKGROUND ART

Display glasses, optical elements, hygienic instruments, etc. are likely to be contacted by human fingers and thus likely to be stained by fingerprints, sebum, sweat, etc. And, such stains may not easily be wiped off and may become distinct depending upon lighting conditions, whereby there has been a problem that the visibility or aesthetic appearance is thereby impaired.

In order to solve such a problem, a method has been known wherein an antifouling film made of a fluorinated organosilicon compound, is formed on the surface of such components or instruments.

For example, Patent Document 1 discloses a method for forming a film by vacuum deposition wherein, as a vaporization source, one having the raw material impregnated to porous ceramic pellets and dried, is used.

However, in a case where a raw material dried before introduced into a vapor deposition device is used as a vaporization source like this, the raw material substance becomes unstable, whereby there has been a problem such that the performance of the obtainable antifouling film is not stable, and the yield tends to be low. Further, a pelletizing step is required, which has created an additional cost.

Further, Patent Document 2 discloses a method wherein a solution containing a fluorinated alkyl group-containing organosilicon compound is heated by electron beams to form a thin film of the compound on a substrate.

However, in the invention disclosed in Patent Document 2, when the raw material is heated for at least the predetermined time, the durability of the obtainable antifouling film tends to be low. Therefore, there has been a problem such that the thickness of the film to be produced, is limited, or it is not possible to produce a highly durable film constantly.

Further, in each method disclosed in Patent Documents 1 and 2, the productivity has been low, since it is required to carry out the operation in a batch system by setting the raw material in such a very small amount that vaporizes within tens of seconds after heating. Further, in order to raise the temperature within a predetermined time, an apparatus to be used, is rather limited, which has been a cause for a high cost.

Further, in each method of Patent Documents 1 and 2, the vapor deposition material is supplied from a single point vaporization source to form a film on the substrate surface, and accordingly deposition treatment is carried out by disposing and fixing the substrate to an arc centering on the vaporization source.

Thus, in order to obtain a uniform film thickness distribution, a long distance between the substrate and the vaporization source is required, and the material utilization efficiency is low. Further, the area to which the deposition material can be supplied should be larger than the substrate area, and since the deposition material is supplied to a fixed substrate, it is necessary to supply the raw material to a range wider than the substrate at all the portion around the outer periphery of the substrate. The deposition material out of the substrate does not contribute to film-forming, which has been a cause for a high cost also.

As described above, by such conventional methods for forming a fluorinated organosilicon compound thin film, only a method for producing an antifouling film in a batch system has been known, and it has been not possible to produce an antifouling film having durability continuously and constantly.

### PRIOR ART DOCUMENTS

### Patent Documents

Patent Document 1: JP-A-2009-175500

Patent Document 2: JP-A-2008-107836

### DISCLOSURE OF INVENTION

### Technical Problem

In view of the above-described problems of the prior art, it is an object of the present invention to provide an apparatus and process for producing a fluorinated organosilicon compound thin film, capable of continuously forming a fluorinated organosilicon compound thin film having high durability while transporting a substrate.

### Solution to Problem

In order to solve the above problems, the present invention provides an apparatus for producing a fluorinated organosilicon compound thin film for forming a fluorinated organosilicon compound thin film on a substrate surface, which comprises:

a chamber,

a heating container for heating a fluorinated organosilicon compound,

a plurality of nozzles for supplying the fluorinated organosilicon compound to a substrate, provided in the chamber and connected to the heating container, and

a substrate transport mechanism for transporting the substrate so that the plurality of nozzles and a surface of the substrate on which a thin film is to be formed face each other,

wherein the plurality of nozzles are arranged in a line so that they cross the direction of transport of the substrate by the substrate transport mechanism, and

the fluorinated organosilicon compound is one subjected to a solvent removal treatment or one not diluted with a solvent.

The present invention further provides a process for producing a fluorinated organosilicon compound thin film by forming a fluorinated organosilicon compound thin film on a substrate surface, which comprises:

heating a fluorinated organosilicon compound subjected to a solvent removal step or a fluorinated organosilicon compound not diluted with a solvent, in a heating container,

supplying the fluorinated organosilicon compound from a plurality of nozzles arranged in a line so that they cross the direction of transport of a substrate, provided in the chamber and connected to the heating container, and

forming a fluorinated organosilicon compound thin film on a surface of the substrate on which a thin film is to be formed, while the substrate is transported by a substrate transport mechanism so that the plurality of nozzles and the surface of the substrate on which a thin film is to be formed face each other.

### Advantageous Effects of Invention

According to the present invention, it is possible to continuously form a fluorinated organosilicon compound thin film having durability, by heating a fluorinated organosilicon compound from which a solvent commonly added to a fluorinated organosilicon compound is removed, or which is not diluted with such a solvent (that is, to which a solvent is not added), and supplying the heated compound to a substrate.

Further, according to the present invention, the construction of an apparatus for producing a fluorinated organosilicon compound thin film particularly the construction around the vaporization source is simplified, and a preparation time for operation of the apparatus (that is, preliminary exhaustion time) can be shortened, and thus the operating efficiency can be increased.

Further, since nozzles for supplying the fluorinated organosilicon compound are arranged in a line so that they cross the direction of transport of the substrate, film-forming while transporting the substrate is possible, and the productivity is thereby increased.

Further, since film-forming is carried out while transporting the substrate, substantially the entire fluorinated organosilicon compound supplied from the nozzles can be supplied without being out of the substrate. Thus, the amount of the material which does not contribute to film-forming can be reduced, and thus the cost can be reduced.

### BRIEF DESCRIPTION OF DRAWINGS

FIG. 1 is a diagram illustrating a production apparatus according a first embodiment of the present invention.

FIG. 2 is a transverse cross-sectional view illustrating a production apparatus according a first embodiment of the present invention.

FIG. 3 illustrates an example of arrangement of nozzles of a production apparatus according a first embodiment of the present invention.

FIG. 4 is a diagram illustrating a modified example of a production apparatus according a first embodiment of the present invention.

FIG. 5 is diagram illustrating a glass substrate carrier in Example of the present invention.

FIGS. 6A and 6B illustrate a film thickness distribution in a glass substrate carrier after film-forming in Example of the present invention.

### DESCRIPTION OF EMBODIMENTS

Now, embodiments of the present invention will be described with reference to the drawings. However, it should be understood that the present invention is by no means limited to such embodiments, and it is possible to add various modifications and substitutions to the following embodiments without departing from the scope of the present invention.

### First Embodiment

Now, the apparatus for producing a fluorinated organosilicon compound thin film according to the present invention will be described.

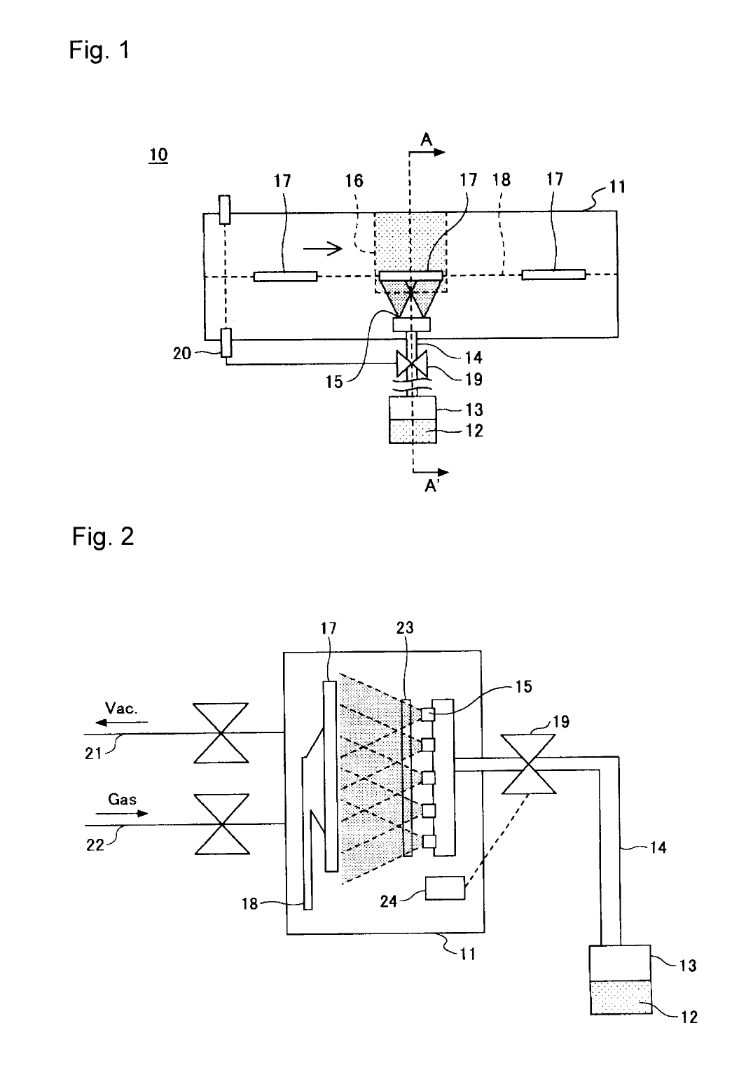

The specific construction will be described with reference to FIGS. 1 to 4. FIGS. 1 to 4 illustrate examples of an apparatus for producing a fluorinated organosilicon compound thin film of the present invention, and the present invention is not limited to such examples.

First, FIG. 1 is a top plan view schematically illustrating an apparatus for producing a fluorinated organosilicon compound thin film according to this embodiment, and FIG. 2 is a transverse cross-sectional view at the line A-A′ in FIG. 1.

An apparatus 10 for producing a fluorinated organosilicon compound thin film according to this embodiment comprises a chamber 11 (more specifically, a vacuum chamber) and a heating container for heating a fluorinated organosilicon compound 12. It further comprises a plurality of nozzles 15 for supplying the fluorinated organosilicon compound to a substrate, provided in the chamber 11 and connected to the heating container 13. It further comprises a substrate transport mechanism for transporting the substrate so that the plurality of nozzles 15 and a surface of the substrate 17 on which a thin film is to be formed face each other, and the plurality of nozzles 15 are arranged in a line so that they cross the direction of transport of the substrate by the substrate transport mechanism 18.

Further, as the fluorinated organosilicon compound, one which is preliminarily subjected to a solvent removal treatment or one which is not diluted with a solvent (that is, one to which a solvent is not added) is used.

In the drawing, the substrate 17 is t transported in the direction of an arrow, and in a region where it faces the plurality of nozzles 15 (that is, an effective deposition region 16), a thin film of the fluorinated organosilicon compound is formed by a vacuum deposition method.

Now, the respective constituting apparatus and members will be described.

The chamber 11 is a vacuum chamber or a reduced pressure chamber, and its size, shape, material, etc. are not limited and may be selected depending upon the size of the substrate to be used, deposition conditions in the chamber, etc.

Further, the chamber 11 may be provided with incidental equipment such as a gas supply piping. For example, it may be provided with a piping 21 connected to a vacuum pump, a piping 22 connected to a gas supply portion, etc. as shown in FIG. 2 so as to achieve a desired degree of vacuum in the inside of the chamber depending upon the deposition conditions or to supply a gas.

With respect to the heating container 13, the size, the shape, the material, etc. are not limited, however, it preferably has pressure resistance in addition to heat resistance, since the pressure in the heating container 13 may be a negative pressure in some cases e.g. when the container is evacuated of air after the fluorinated organosilicon compound is introduced.

Further, the heating container may be provided with a piping connected to a vacuum pump or a gas supply portion, so as to control the atmosphere in the heating container. The heating temperature of the heating container when film-forming is carried out by a vacuum deposition method varies depending upon the fluorinated organosilicon compound to be used, the deposition rate, etc. and is not limited, and the heating container may be heated so as to obtain a required deposition rate.

With respect to a fluorinated organosilicon compound supply path (that is, a piping) 14 connecting the heating container and the plurality of nozzles, the shape and the material are not particularly limited and may be selected depending upon the deposition rate required, the number of nozzles, etc. For example, it may be constituted by a manifold, or may be constituted by a plurality of pipings respectively connecting the respective nozzles and the heating container. Further, the fluorinated organosilicon compound supply path 14 is also preferably heated so that the fluorinated organosilicon compound which is vaporized in the heating container will not condense until it reaches the respective nozzles from the heating container.

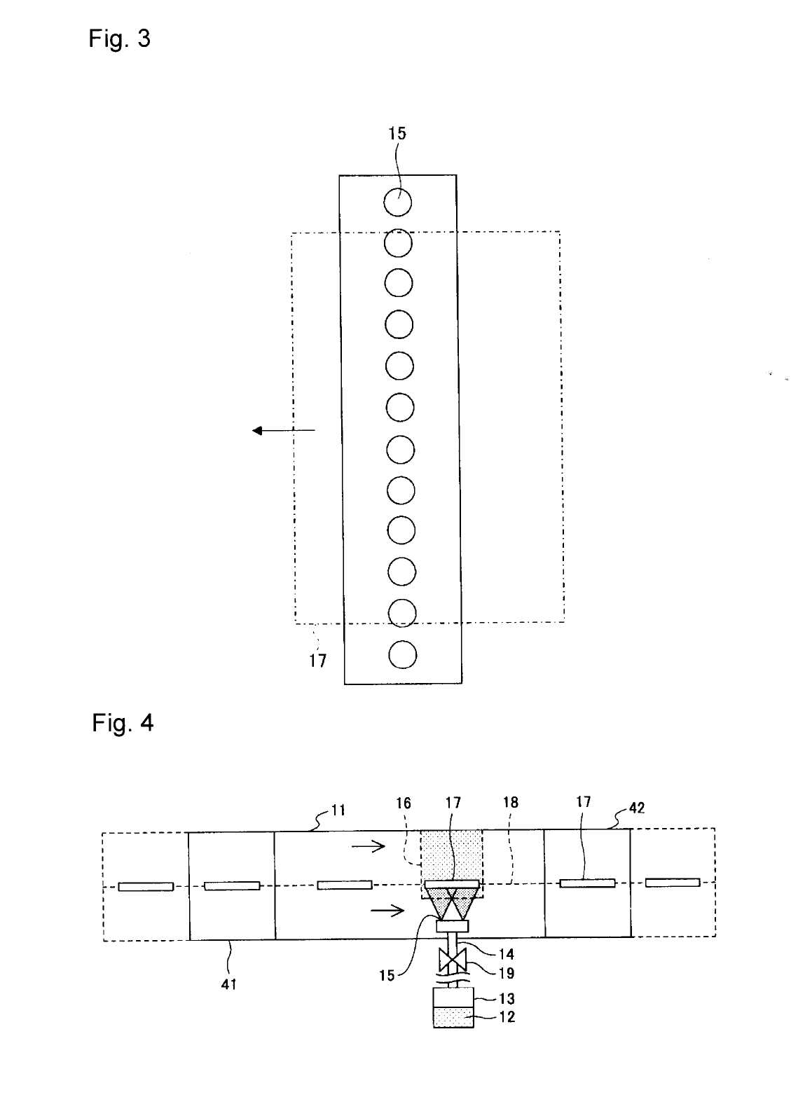

Now, arrangement of the nozzles 15 will be described with reference to FIG. 3.

The nozzles 15 are arranged in a line so that they cross the direction of transport of the substrate 17 (that is, the direction indicated by an arrow in the drawing) in a range broader than the width in the direction vertical to the direction of transport of the substrate. The nozzles may be arranged in one line as shown in FIG. 3 for example. On that occasion, the number of lines of the nozzles is not particularly limited and may be defined depending upon the type of the fluorinated organosilicon compound to be used, the transport rate of a substrate transport apparatus, the deposition conditions, etc.

The above arrangement of the nozzles in a line of the present invention may be one or a plurality of lines so that the nozzles cross the transport direction at right angles or at a predetermined angle to the direction of transport of the substrate. In a case where nozzles in a plurality of lines are used, the nozzle positions of the respective lines may be shifted with a certain phase, whereby the film thickness distribution in the entire substrate can be more uniformly controlled.

Further, the intervals between the nozzles, arrangement and the opening size are not limited, and are preferably selected so that a film can uniformly be formed in a region on the substrate on which a thin film is to be formed.

Further, the nozzles are arranged so as to face the surface of the substrate on which a thin film is to be formed. In FIGS. 1 and 2, the substrate (hereinafter sometimes referred to as a base plate) is held in a direction vertical to the ground surface, and the nozzles are arranged to face the substrate, and accordingly the fluorinated organosilicon compound is sprayed in a horizontal direction. However, the present invention is not limited to such an embodiment, and for example, the substrate may be held horizontally to the ground, and the compound is sprayed from the top or bottom side. Otherwise, the nozzles may be provided to face both the surfaces of the substrate, whereby films are formed simultaneously on both the front and the rear surfaces of the substrate.

In a case where a film is to be formed on the entire base plate, as an example, a method may be employed wherein the substrate is held and transported in such a state that it is placed on a back board on an inclined carrier. In such a case, the distance between the base plate surface and the facing nozzles may be constant on any part of the substrate. For example, the film thickness distribution on the entire substrate can be controlled more uniformly by inclining the line of the nozzles at the same degree as that of the substrate or by adjusting the opening size of the nozzles, so that the center of the direction of spray of the fluorinated organosilicon compound from each nozzle is vertical to the substrate. On the other hand, the distance between the base plate surface and the facing nozzles may be adjusted to vary at a certain rate per each line of the nozzles. In such a manner, it is possible to form a gradient film in which the film thickness varies at a certain rate in a predetermined direction on the base plate.

Further, it is preferred that among the plurality of nozzles, a nozzle supplying the fluorinated organosilicon compound to the substrate can be selected.

By such a construction, for example, in a case where a deposition treatment is carried out to a substrate having a size smaller than the specification of the production apparatus, it is possible to supply the fluorinated organosilicon compound to a range in accordance with the size of the substrate, and it is thereby possible to reduce the amount of supply of the raw material which will not contribute to deposition. Thus, it is possible to reduce the cost.

A means to make it possible to select the nozzle supplying the fluorinated organosilicon compound as the deposition material to the substrate, that is, a means to stop supply of the raw material from a predetermined nozzle, is not particularly limited. For example, a method of capping the nozzle not supplying the deposition material e.g. by a screw or a method of providing a valve on a fluorinated organosilicon compound supply path from the heating container to the nozzle and closing the valve on the predetermined supply path so as not to supply the deposition material, may, for example, be mentioned.

Between the substrate 17 and the nozzles 15, a cooling plate 23 as shown in FIG. 2 may be provided so as to prevent the radiation heat from the fluorinated organosilicon compound supply path from being transmitted to the substrate 17. The shape, etc. of the cooling plate are not limited, and the cooling plate is disposed so as not to inhibit supply of the deposition material from the nozzles 15.

The substrate 17 is not particularly limited, and various substrates made of e.g. glass, a plastic or a metal which are required to have an antifouling film, a water repellent film or an oil repellent film, may be employed. Further, as its shape, it may be a flat plate or may be one formed into a desired shape.

The substrate transport mechanism 18 is one which can transport the substrate 17 so that the plurality of nozzles 15 and the surface of the substrate 17 on which a thin film is to be formed face each other in the chamber 11. Particularly, since the present production apparatus is capable of forming a film continuously on a plurality of substrates, the mechanism 18 is preferably one which can continuously supply a plurality of substrates to a region where the substrates face the plurality of nozzles 15 (effective deposition region 16). It is preferred to supply substrates continuously and to carry out a deposition treatment on the plurality of substrates in such a manner, whereby the productivity will be high.

The substrate transport mechanism commonly holds the substrate mechanically, for example, by holding the substrate with an inclination or by holding the circumference of the substrate by jigs with spring at several points. In a case where the substrate is held with an inclination, for example, the base plate is placed on a back board of a carrier inclined at about 5° to the vertical direction. Further, in the case of a relatively small substrate, a method of holding and fixing the substrate by a substrate-holding member such as a suction pad or an electrostatic chuck and transporting the substrate-holding member e.g. by a rack-and-pinion mechanism may, for example, be mentioned.

Further, the substrate transport mechanism is preferably capable of changing the rate of transport of the substrate depending upon the deposition rate for the fluorinated organosilicon compound thin film. By the substrate transport mechanism being capable of changing the rate of transport of the substrate, it is possible to form a fluorinated organosilicon compound thin film having a desired film thickness, and wasteful consumption of the raw material can be suppressed, and the yield can be improved.

Further, the apparatus is preferably provided with a substrate sensor 20 defecting passage of the substrate provided on the upstream of the plurality of nozzles in the substrate transport path, and a valve 19 capable of adjusting, stopping and restarting supply of the fluorinated organosilicon compound, provided on the fluorinated organosilicon compound supply path connecting the plurality of nozzles and the heating container. Further, it is preferred that the valve 19 is closed when the substrate sensor 20 detects absence of passage of the substrate for a certain time, and the valve 19 is opened when the substrate sensor 20 detects passage of the substrate again.

For example, in the case of FIG. 1, the substrate sensor 20 may be provided on the upstream of the plurality of nozzles in the substrate transport path. Further, it can be interlocked with the valve 19 provided on the fluorinated organosilicon compound supply path connecting the plurality of nozzles 15 and the heating container 13.

The substrate sensor 20 is one which can detects whether the substrate passes on the substrate supply path and is supplied, and the type of the sensor is not particularly limited, and it may, for example, be an infrared sensor.

Further, the valve 19 is not particularly limited so long as it can be opened and closed by signals from the substrate sensor 20, and it may, for example, be a stop valve.

The time from when the substrate sensor 20 detects absence of passage and supply of the substrate on the substrate supply path until when the valve 19 is closed is not particularly limited and may be selected depending upon the operating environment when the apparatus is used, etc.

The raw material fluorinated organosilicon compound is commonly expensive, and the amount of the raw material not supplied to the substrate is preferably small. Accordingly, by the above construction, it is possible to reduce the cost.

Further, on the supply path connecting the heating container and the plurality of nozzles, a variable valve is provided so as to make it possible to change the amount of supply of the fluorinated organosilicon compound, and opening of the variable valve is preferably controlled in accordance with the detected value of a film thickness meter provided in the chamber.

The opening of the variable valve is adjusted in accordance with the output of a film thickness meter 24 provided in the chamber 11 as shown in FIG. 2. As the variable valve, as shown in FIGS. 1 and 2, the valve 19 interlocking with the substrate sensor 20 may function as the variable valve, or the variable valve may be provided separately from the valve 19.

The deposition rate can be corrected by opening of the variable valve in accordance with the detected value of the film thickness meter, thereby to form a film at a desired deposition rate. Further, it is also possible to change the deposition rate depending upon the substrate, and different types of products can be continuously produced, whereby the productivity will be increased.

Further, in the above-described apparatus for producing a fluorinated organosilicon compound thin film, in a case where substrates are introduced from and withdrawn to an environment in an atmosphere (for example, the atmospheric pressure atmosphere) different from that in the chamber, a substrate introduction chamber (also referred to as a substrate introduction front chamber) and a substrate-withdrawing chamber may be disposed so as to continuously supply substrates into the chamber.

Specifically, a substrate introduction chamber to introduce substrates into the chamber and a substrate-withdrawing chamber to withdraw the substrates from the chamber are connected to the chamber. And, the substrate introduction chamber and the substrate-withdrawing chamber may be individually constructed to be capable of evacuation and venting, and the substrate transport mechanism can transport substrates among the substrate introduction chamber, the chamber and the substrate-withdrawing chamber.

A specific construction of the production apparatus will be described with reference to FIG. 4. The same constituting apparatus and members as in FIGS. 1 and 2 have the same symbols.

As shown in FIG. 4, a substrate introduction chamber (front chamber) 41 to introduce substrates into the chamber and a substrate-withdrawing chamber 42 to withdraw the substrates are connected to the chamber 11. Further, the substrate introduction chamber 41 and the substrate-withdrawing chamber 42 are individually constructed to be capable of evacuation and venting. That is, for example, a vacuum piping connected to a vacuum pump and a gas supply piping to supply a gas may be provided to each of them. Further, they preferably have an openable and closable inlet and outlet to introduce and withdraw substrates.

Further, between the substrate introduction chamber, the chamber and the substrate-withdrawing chamber, a wall (gate) which can be opened and closed and which can maintain airtightness of the respective rooms when it is closed, is preferably provided. Such a gate is not limited so long as at least a range at which substrates pass can be opened and closed, and it may be constructed, for example, by a gate valve.

Further, the apparatus is constructed so that substrates can be transported by the substrate transport mechanism among the substrate introduction chamber, the chamber and the substrate-withdrawing chamber, and accordingly substrates can be transported by the substrate transport apparatus from the substrate introduction chamber to the chamber and to the substrate-withdrawing chamber.

The substrate transport mechanism does not necessarily consist of a single construction from the substrate introduction chamber to the chamber and to the substrate-withdrawing chamber, and it may be constructed by separate substrate transport mechanisms for the substrate introduction chamber, the chamber and the substrate-withdrawing chamber, so that the substrates can be transferred from one room to another.

Further, disposition of the substrate introduction chamber, the chamber and the substrate-withdrawing chamber is not particularly limited so long as these three rooms are continuously disposed, and disposition can be selected depending upon conditions such as the disposition location. For example, as shown in FIG. 4, it is preferred to linearly dispose the three rooms, whereby the footprint is small, and the transport mechanism is simple.

By such a construction, while deposition treatment is carried out in the chamber, a step of disposing a substrate to which deposition treatment is to be carried out next in the substrate introduction chamber and adjusting the atmosphere in the substrate introduction chamber to be the same as in the chamber can be carried out simultaneously. Further, a thin film-formed substrate is transferred to the substrate-withdrawing chamber, the atmosphere in the chamber and the atmosphere in the substrate-withdrawing chamber are separated by the wall, and then the substrate can be withdrawn from the substrate-withdrawing chamber. As described above, even when the substrate is introduced from and withdrawn into an environment having an atmosphere different from that in the chamber, substrates can be continuously supplied without destroying the atmosphere in the chamber, whereby the productivity will be increased.

Now, the fluorinated organosilicon compound used in the present invention will be described. The fluorinated organosilicon compound used in the present invention is not particularly limited so long as it can impart antifouling property, water repellency and oil repellency.

Specifically, it may be a fluorinated organosilicon compound having at least one group selected from the group consisting of a perfluoropolyether group, a perfluoroalkylene group and a perfluoroalkyl group. The perfluoropolyether group is a bivalent group having such a structure that a perfluoroalkylene group and an etheric oxygen atom are alternately bonded.

Specific examples of the fluorinated organosilicon compound having at least one group selected from the group consisting of a perfluoropolyether group, a perfluoroalkylene group and a perfluoroalkyl group include compounds represented by the following formulae (I) to (V).

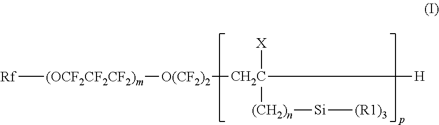

In the formula, Rf is a C₁₋₁₆ linear perfluoroalkyl group (the alkyl group may, for example, be a methyl group, an ethyl group, a n-propyl group, an isopropyl group or a n-butyl group), X is a hydrogen atom or a C₁₋₅ lower alkyl group (such as a methyl group, an ethyl group, a n-propyl group, an isopropyl group or a n-butyl group), R1 is a hydrolyzable group (such as an amino group or an alkoxy group) or a halogen atom (such as fluorine, chlorine, bromine or iodine), m is an integer of from 1 to 5, preferably from 1 to 30, n is an integer of from 0 to 2, preferably from 1 to 2, and p is an integer of from 1 to 10, preferably from 1 to 8.

C_{q}F_{2q+1}CH₂CH₂Si(NH₂)₃ (II)

In the formula, q is an integer of at least 1, preferably from 2 to 20.

The compound represented by the formula (II) may, for example, be n-trifluoro(1,1,2,2-tetrahydro)propylsilazane (n-CF₃CH₂CH₂Si(NH₂)₃) or n-heptafluoro(1,1,2,2-tetrahydro)pentylsilazane (n-C₃F₇CH₂CH₂Si(NH₂)₃).

C_{q′}F_{2q′+1}CH₂CH₂Si(OCH₃)₃ (III)

wherein q′ is an integer of at least 1, preferably from 1 to 20.

The compound represented by the formula (III) may, for example, be 2-(perfluorooctyl)ethyltrimethoxysilane (n-C₈F₁₇CH₂CH₂Si(OCH₃)₃).

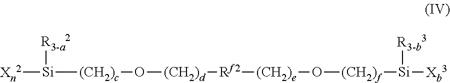

In the formula (IV), R^{f2} is a bivalent linear perfluoropolyether group represented by —(OC₃F₆)ₛ—(OC₂F₄)ₜ—(OCF₂)ᵤ— (wherein each of s, t and u which are independent of one another, is an integer of form 0 to 200), and each of R² and R³ which are independent of each other, is a C₁₋₈ monovalent hydrocarbon group (such as a methyl group, an ethyl group, a n-propyl group, an isopropyl group or a n-butyl group). Each of X² and X³ which are independent of each other, is a hydrolyzable group (such as an amino group, an alkoxy group, an acyloxy group, an alkenyloxy group or an isocyanate group) or a halogen atom (such as a fluorine atom, a chlorine atom, a bromine atom or an iodine atom), each of d and e which are independent of each other, is an integer of from 1 to 2, each of c and f which are independent of each other, is an integer of from 1 to 5 (preferably from 1 to 2), and each of a and b which are independent of each other, is 2 or 3.

In R^{f2} in the compound (IV), s+t+u is preferably from 20 to 300, more preferably from 25 to 100. Further, each of R² and R³ is preferably a methyl group, an ethyl group or a butyl group. The hydrolyzable group represented by each of X² and X³ is preferably a C₁₋₆ alkoxy group, particularly preferably a methoxy group or an ethoxy group. Further, each of a and b is preferably 3.

F—(CF₂)ᵥ—(OC₃F₆)_{w}—(OC₂F₄)_{y}—(OCF₂)_{z}(CH₂)ₕO(CH₂)ᵢ—Si(X⁴)₃₋ₖ(R⁴)ₖ (V)

In the formula (V), v is an integer of from 1 to 3, each of w, y and z which are independent of one another, is an integer of from 0 to 200, h is 1 or 2, i is an integer of form 2 to 20, X⁴ is a hydrolyzable group, R⁴ is a C₁₋₂₂ linear or branched hydrocarbon group, and k is an integer of from 0 to 2. w+y+z is preferably from 20 to 300, more preferably from 25 to 100. Further, i is preferably 2 to 10. X⁴ is preferably a C₁₋₆ alkoxy group, more preferably a methoxy group or an ethoxy group. R⁴ is preferably a C₁₋₁₀ alkyl group.

Further, as commercially available fluorinated organosilicon compound having at least one group selected from the group consisting of a perfluoropolyether group, a perfluoroalkylene group and a perfluoroalkyl group, KP-801 (tradename, manufactured by Shin-Etsu Chemical Co., Ltd.), KY178 (tradename, manufactured by Shin-Etsu Chemical Co., Ltd.), KY-130 (tradename, manufactured by Shin-Etsu Chemical Co., Ltd.), KY185 (tradename, manufactured by Shin-Etsu Chemical Co., Ltd.), OPTOOL (registered trademark), STF-U (tradename, manufactured by DAIKIN INDUSTRIES, LTD.), OPTOOL (registered trademark), STF-S (tradename, manufactured by DAIKIN INDUSTRIES, LTD.), OPTOOL (registered trademark), DSX (tradename, manufactured by DAIKIN INDUSTRIES, LTD.) and OPTOOL AES (tradename, manufactured by DAIKIN INDUSTRIES, LTD.) may, for example, be preferably used.

The fluorinated organosilicon compound is usually stored as mixed with a solvent such as a fluorinated solvent in order to suppress deterioration by reaction with moisture in the air, however, if the compound is subjected to the deposition treatment as it contains such a solvent, the durability of the obtained thin film, etc., may be deteriorated.

Accordingly, in the present invention, a fluorinated organosilicon compound which is preliminarily subjected to a solvent removal treatment before heating in the heating container or a fluorinated organosilicon compound which is not diluted with a solvent (that is, to which no solvent is added) is used. That is, at least one member selected from the group consisting of a fluorinated organosilicon compound which is preliminarily subjected to a solvent removal treatment and a fluorinated organosilicon compound which is not diluted with a solvent is used. For example, the concentration of the solvent contained in a solution of the fluorinated organosilicon compound subjected to a solvent removal treatment is preferably at most 1 mol %, more preferably at most 0.2 mol %. It is particularly preferred to use a fluorinated organosilicon compound containing no solvent.

Here, the solvent used when the fluorinated organosilicon compound is stored may, for example, be perfluorohexane, m-xylene hexafluoride (C₆H₄(CF₃)₂), hydrofluoropolyether or HFE7200/7100 (tradename, manufactured by Sumitomo 3M Ltd., HFE7200 represents C₄F₉C₂H₅, and HFE7100 represents C₄F₉OCH₃).

The treatment to remove the solvent (solvent medium) from the fluorinated organosilicon compound solution containing the fluorinated solvent may be carried out, for example, by evacuating a container in which the fluorinated organosilicon compound solution is put.

The evacuation time varies e.g. the evacuation line, the evacuation capacity of e.g. a vacuum pump, and the amount of the solution, and is not limited, and may be at least about 10 hours for example.

Such operation may be carried out by evacuating the heating container at room temperature after the fluorinated organosilicon compound solution is introduced into the heating container and before it is heated. Otherwise, the solvent removal step may be preliminarily carried out e.g. by an evaporator before the solution is introduced into the heating container.

However, as described above, the fluorinated organosilicon compound solution containing a low solvent content or the fluorinated organosilicon compound solution containing no solvent is likely to be deteriorated by contact with the air as compared with one containing a solvent.

Accordingly, it is preferred that the system in the storage container for the fluorinated organosilicon compound solution having a low solvent content or the fluorinated organosilicon compound solution containing no solvent is preferably replaced with an inert gas such as nitrogen and then the storage container is hermetically closed, and when the solution is handled, the time of exposure to and contact with the air is shorter.

Specifically, it is preferred that immediately after the storage container is opened, the fluorinated organosilicon compound is introduced to the heating container of the present production apparatus. Further, it is preferred that after the introduction, the heating container is evacuated of air, or the system in the heating container is replaced with an inert gas such as nitrogen or a rare gas to remove the atmosphere (that is, the air) contained in the heating container. In order that the fluorinated organosilicon compound solution can be introduced from the storage container (that is, a stock container) to the heating container of the present production apparatus without being contacted with the air, for example, it is preferred that the storage container and the heating container are connected by a piping with a valve.

Further, it is preferred that after the fluorinated organosilicon compound is introduced to the heating container and the container is evacuated of air or the system in the container is replaced with an inert gas, heating for vacuum deposition is immediately started.

### Second Embodiment

Now, the process for producing a fluorinated organosilicon compound thin film according to this embodiment will be described.

The process for producing a fluorinated organosilicon compound thin film according to this embodiment is a process for producing a fluorinated organosilicon compound thin film as follows. A fluorinated organosilicon compound subjected to a solvent removal treatment or a fluorinated organosilicon compound not diluted with a solvent is heated in a heating container. The fluorinated organosilicon compound is supplied to a substrate from a plurality of nozzles arranged in a line so that they cross the direction of transport of the substrate, provided in the chamber and connected to the heating container. And, a fluorinated organosilicon compound thin film is formed on a surface of the substrate on which a thin film is to be formed, while the substrate is transported by a substrate transport mechanism so that the plurality of nozzles and the surface of the substrate on which a thin film is to be formed face each other.

According to the present production process, a fluorinated organosilicon compound from which a solvent commonly added to a fluorinated organosilicon compound is preliminarily removed or to which a solvent is not added, is heated and supplied to a substrate. Accordingly, it is possible to continuously form a film having durability.

Further, since nozzles for supplying the fluorinated organosilicon compound are arranged in a line so that they cross the direction of transport of the substrate, film-forming is possible while transporting the substrate, and the productivity can be increased. Here, “in a line” is as described in the first embodiment.

Further, since film-forming is carried out while transporting the substrate, the fluorinated organosilicon compound supplied from each nozzle can be supplied to the substrate substantially without being out of the substrate. Thus, the amount of the raw material which does not contribute to deposition can be reduced, and the cost can be reduced.

Further, it is preferred that among the plurality of nozzles, a nozzle supplying the fluorinated organosilicon compound to the substrate can be selected.

By such a construction, for example, in a case where a deposition treatment is carried out to a substrate having a size smaller than the specification of the production apparatus, it is possible to supply the fluorinated organosilicon compound to a range in accordance with the size of the substrate, and it is thereby possible to reduce the amount of supply of the raw material which will not contribute to deposition. Thus, the cost can be reduced.

A means to make it possible to select the nozzle supplying the fluorinated organosilicon compound as the deposition material to the substrate, that is, a means to stop supply of the material from a predetermined nozzle, is not particularly limited. For example, a method of capping the nozzle not supplying the deposition material e.g. by a screw, or a method of providing a valve on a fluorinated organosilicon compound supply path from the heating container to the nozzle and closing the valve, so that the deposition material is not supplied from the predetermined nozzle, may, for example, be mentioned.

The nozzle which does not supply the deposition material to the substrate can be selected to suppress supply of the raw material to a portion other than the portion of the substrate on which a thin film is to be formed, by the size of the substrate on which deposition is carried out, the spray pressure of the deposition material from the nozzle, disposition, the distance between the nozzle and the substrate, etc.

Further, a substrate sensor detecting passage of the substrate, provided on the upstream of the plurality of nozzles in the substrate transport path, and a valve provided on a fluorinated organosilicon compound supply path connecting the plurality of nozzles and the heating container, are preferably provided. Further, it is preferred that the valve is closed when the substrate sensor detects absence of passage of the substrate for a certain time, and the valve is opened when the substrate sensor detects passage of the substrate again.

With reference to FIG. 1, for example, a substrate sensor 20 may be provided on the upstream of a plurality of nozzles in the substrate transport path. Further, it may be interlocked with a valve 19 provided on a fluorinated organosilicon compound supply path connecting a plurality of nozzles 15 and a heating container 13.

The substrate sensor 20 is one which can detect passage of the substrate, and the type of the sensor is not particularly limited, and it may, for example, be an infrared sensor.

Further, the valve 19 is not particularly limited so long as it can be opened and closed by signals from the substrate sensor 20, and it may, for example, be a stop valve.

The time from when the substrate sensor 20 detects absence of passage of the substrate until when the valve 19 is closed is not particularly limited and may be selected depending upon the operating environment when the apparatus is used, etc.

The raw material fluorinated organosilicon compound is commonly expensive, and the amount of the raw material not supplied to the substrate is preferably small. Accordingly, by the above construction, it is possible to reduce the cost.

Further, it is preferred that a variable valve capable of changing the amount of supply of the fluorinated organosilicon compound is provided on a supply path connecting the heating container and the plurality of nozzles, and opening of the variable valve is controlled in accordance with the detected value of a film thickness meter provided in the chamber.

The deposition rate can be controlled by opening of the variable value in accordance with the detected value of the film thickness meter, and accordingly deposition can be carried out at a desired deposition rate. Further, it is also possible to change the deposition rate depending upon the substrate, and different types of products can continuously be produced, whereby the productivity will be increased.

Further, in a case where both the substrate sensor and a valve interlocking with the substrate sensor are provided, one valve which functions as the variable valve and the valve interlocking with the substrate sensor may be provided, or separate valves for the respective applications may be provided.

Further, the substrate transport mechanism is preferably capable of changing the rate of transport of the substrate in accordance with the deposition rate for the fluorinated organosilicon compound thin film

By the substrate transport mechanism being capable of changing the rate of transport of the substrate, it is possible to form a fluorinated organosilicon compound thin film having a desired film thickness, and wasteful consumption of the raw material can be suppressed, and the yield can be improved.

Further, as described in the first embodiment, to the chamber, a substrate introduction chamber and a substrate-withdrawing chamber individually constructed to be capable of evacuation and venting are preferably connected. Further, it is preferred that the substrate introduced into the substrate introduction chamber is transported to the chamber by the substrate transport mechanism, and after deposition treatment, the substrate is transported by the substrate transport mechanism from the chamber to the substrate-withdrawing chamber.

By such a construction, while deposition treatment is carried out in the chamber, a step of disposing a substrate to which deposition treatment is to be carried out next in the substrate introduction chamber and adjusting the atmosphere in the substrate introduction chamber to be the same as in the chamber, is carried out simultaneously. Further, a thin film-formed substrate is transferred to the substrate-withdrawing chamber, the atmosphere in the chamber and the atmosphere in the substrate-withdrawing chamber are separated by a wall, and then the substrate can be withdrawn from the substrate-withdrawing chamber. Accordingly, even when the substrate is introduced from and withdrawn into an environment (for example, an atmospheric pressure atmosphere) different form that in the chamber, substrates can be introduced and withdrawn continuously without destroying the atmosphere in the chamber, whereby the productivity will be increased.

In the above-described process for producing a fluorinated organosilicon compound thin film according to this embodiment, for example, the apparatus for producing a fluorinated organosilicon compound thin film according to the first embodiment may preferably be used. Thus, the respective constituting apparatus, members, fluorinated organosilicon compound as the raw material, etc., other than those described above are the same as in the first embodiment, and their explanation is omitted.

### Example

Now, the present invention will be described in further detail with reference to specific Example. However, it should be understood that the present invention is by no means restricted to this Example.

In this Example, SPD-850VT inline sputtering apparatus (manufactured by ULVAC, Inc.) provided with a plane vaporization source (linear source vaporization source) (manufactured by Hitachi Zosen Corporation) was used as the deposition apparatus. As the plane vaporization source, two lines of nozzles are linearly arranged so that they cross the direction of transport of a substrate (that is, in a direction vertical to the direction of transport of the substrate), and the opening size and disposition of the respective nozzles are designed so that a thin film obtainable by deposition has a film thickness distribution within 10% within a range of 550 mm in the substrate height direction.

The substrate transport mechanism was so disposed that the distance between the substrate and the nozzles of the plane vaporization source was kept at 50 mm.

The scheme of the apparatus used is the same as shown in FIGS. 1 and 2, and the apparatus is to carry out deposition treatment in such a manner that substrates are held in a vertical direction and transported and supplied by the substrate transport mechanism to an effective deposition region provided with the plane vaporization source.

### (Forming of Antifouling Film on Glass Base Plate)

First, as the fluorinated organosilicon compound as the vapor deposition material, 50 g of KY178 (tradename, manufactured by Shin-Etsu Chemical Co., Ltd.) which was not diluted with a solvent (that is, which contained no solvent) was put into a crucible made of SUS304, as the heating container of the deposition apparatus.

On that occasion, supply of the fluorinated organosilicon compound to the crucible was carried out in the air. Accordingly, within 15 minutes after the fluorinated organosilicon compound was exposed to the air, the crucible was evacuated of air to a pressure of at most 5×10⁻² Pa by a vacuum pump.

Then, the crucible was heated to 200° C. After the temperature reached 200° C., the fluorinated organosilicon compound was supplied from the respective nozzles, and substrates were transferred by the substrate transport mechanism so that the respective nozzles and a face of the substrates on which a thin film was to be formed faced each other.

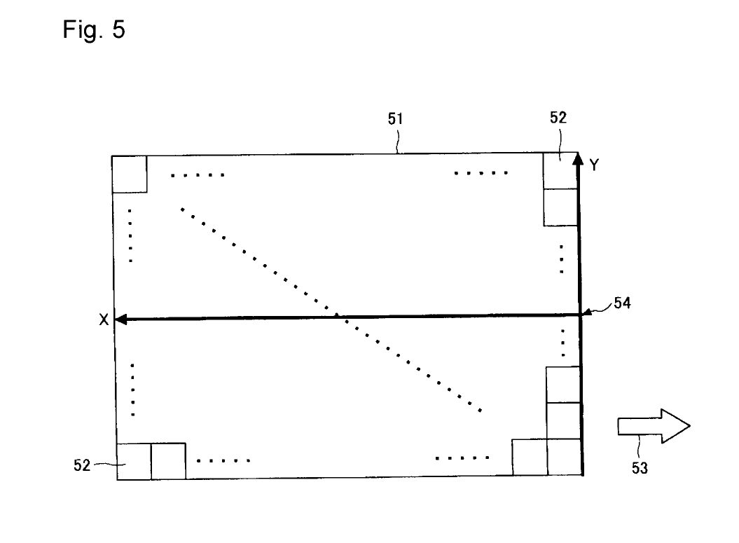

As the substrate, a 100 mm square glass base plate (tradename: Dragontrail, manufactured by Asahi Glass Company, Limited) having a thickness of 1.1 mm was used. As shown in FIG. 5, a plurality of 100 mm square glass base plates 52 disposed in a carrier 51 of 850 mm in a height direction (the direction indicated by an arrow Y in FIG. 5) and 1,200 mm in a direction vertical to the transport direction 53 (the direction indicated by an arrow X in FIG. 5) and held in a vertical direction, were transported to and passed through the plane vaporization source by the substrate transport mechanism to carry out deposition treatment.

Further, the vapor deposition amount was adjusted so that the film thickness of the film formed on the surface of the glass base plate was about 12 nm when the glass base plate passed the deposition region (effective deposition region) at a rate of 900 mm/min.

The vapor deposition amount was adjusted by measuring the vapor deposition amount by a crystal oscillator monitor provided in the vacuum chamber in which the plane vaporization source was placed, and controlling the opening of a valve provided on a piping connecting the heating container and the nozzle. Further, in a case where a desired vapor deposition amount could not be obtained even if the valve was opened to an opening of 80%, the crucible temperature was increased by 10° C.

While adjustment of the vapor deposition amount was continued, the base plates were transported at a constant rate of 900 mm/min to continuously supply the glass base plates, to prepare glass base plates having an antifouling film comprising a fluorinated organosilicon compound formed thereon. As a result, 53 hours after initiation of deposition, the crucible temperature was increased to 290° C., and the desired vapor deposition amount could not be obtained even if the valve opening was 80%, and accordingly deposition was completed.

Further, as the glass base plates, ones having their surface preliminarily treated were used. Specifically, the surface of each base plate was washed by the following procedure.

[1] Ultrasonic cleaning with an alkali detergent SUNWASH TL-75 (2%).

[2] Ultrasonic washing with ultrapure water.

The glass base plates having deposition treatment applied thereto were withdrawn from the vacuum chamber and disposed in a high temperature chamber PR-1SP (manufactured by ESPEC Corp.) so that the film faces stood vertical to the ground surface, and subjected to heat treatment in air atmosphere at 90° C. for 60 minutes and then subjected to a film durability test.

### (Film Durability Test)

1 μL of pure water was dropped on the glass base plate having deposition treatment applied thereto by the above method, and the contact angle was measured and taken as the initial water contact angle.

Then, the thin film-formed side of each substrate was rubbed with cotton (standard adjacent fabrics for staining of colour fastness test) as a rubbing material using a plane abrasion tester PA300A manufactured by DAIEI KAGAKU SEIKI MFG. CO., LTD. for 50,000 reciprocations i.e. 100,000 times at a speed of 107 mm/sec while exerting a pressure of 1,000 g/cm². Then, the contact angle was measured in the same manner as in the case of the initial water contact angle. And, the change from the initial water contact angle was calculated. The results are shown in Table 1. In the Table, the elapsed time after the deposition initiation temperature was reached means a time from when the crucible temperature reached the initial vapor deposition temperature of 200° C. and deposition was started until when deposition on each glass base plate as the sample was started.

For example, an elapsed time after the deposition initiation temperature was reached of 2 hours means a glass substrate on which deposition was started 2 hours after the crucible temperature reached 200° C.

TABLE 1

| Elapsed time | | | | |
|---|---|---|---|---|
| after deposition | Temperature | | | |
| initiation | at the time | Initial | Contact angle | |
| temperature | of vapor | contact | after rubbing | Change in |
| was reached | deposition | angle | for 100,000 | water contact |
| (hr.) | (° C.) | (°) | times (°) | angle (%) |
| 2 | 200 | 118.2 | 117.8 | −0.34 |
| 12 | 205 | 116 | 112.4 | −3.10 |
| 22 | 230 | 114.8 | 114.1 | −0.61 |
| 32 | 250 | 116.1 | 111.7 | −3.79 |
| 42 | 270 | 116.7 | 116.4 | −0.26 |
| 52 | 290 | 117.8 | 116.9 | −0.76 |

It is found from Table 1 that the film had high durability with a decrease in the water contact angle after rubbing 100,000 times of at most 5% even after an elapsed time of about 50 hours from initiation of deposition. Further, it is further found that the temperature at the time of vapor deposition also had little influence over the durability of the film. That is, according to the production process of the present invention, it is possible to produce a film having a high durability constantly for a long period of time.

### (Results of Measurement of Film Thickness Distribution)

The film thickness distribution was confirmed by a spectroscopic ellipsometry method by an ellipsometer (manufactured by Horiba, Ltd.).

Film thickness distribution measurement was carried out with respect to a sample having a thin film formed after an elapsed time of 3 hours after the crucible temperature reached 200° C.

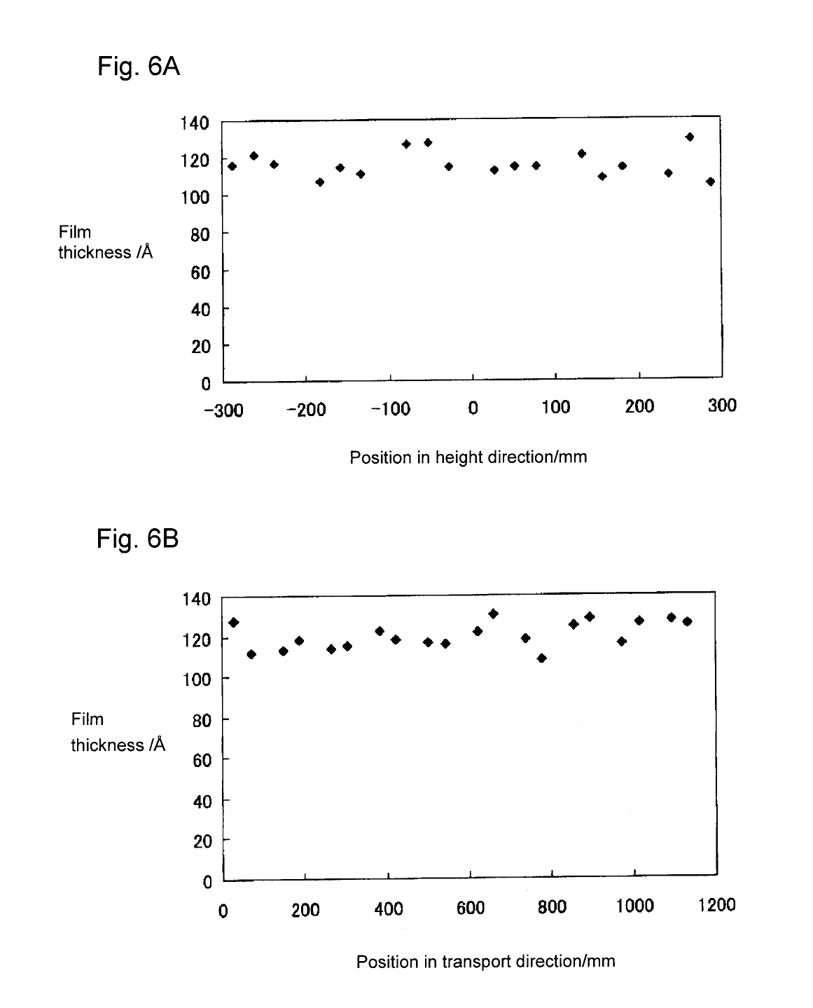

The results of measurement are shown in FIGS. 6A and 6B.

FIG. 6A illustrates the film thickness distribution of a fluorinated organosilicon compound thin film formed on a glass base plate disposed in the carrier, in the height direction in the carrier.

In FIG. 6A, the position in the height direction means a length in the direction indicated by an arrow Y in FIG. 5, and a center portion 54 in the vertical direction in the carrier is represented as 0, and the upper side thereof (the direction indicated by the arrow Y) is represented as positive and the lower side thereof is represented as negative. The film thickness distribution in the height direction is the film thickness distribution measured in the height direction at a position of 600 mm in the after-mentioned transport direction.

FIG. 6B illustrates the results of measurement of the film thickness distribution of a fluorinated organosilicon compound thin film formed on a glass base plate disposed in the carrier, in the transport direction (horizontal direction) in the carrier.

In FIG. 6B, the position in the transport direction means the length in the direction indicated by an arrow X in FIG. 5, that is, the distance from the center portion 54 of the carrier which is the tip of the carrier in the transport direction 53, in a vertical direction (the direction indicated by the arrow X). The film thickness distribution in the transport direction is measured at a position in each transport direction at a position of 0 mm (the center portion 54 of the carrier) in the height direction.

First, from the results shown in FIG. 6A, the film thickness was about 120 Å at all the measured points, and a film thickness distribution of about ±10.5% was obtained. Further, from the results in FIG. 6B, the film thickness was about 120 Å also at all the measured points in the transport direction, and a film thickness distribution of about ±9.4% was obtained.

From the above results, it was confirmed that a film thickness distribution of about ±10% was obtained both in the height direction and in the transport direction, by the linear source vaporization source used in this Example.

### INDUSTRIAL APPLICABILITY

According to the present invention, it is possible to form a fluorinated organosilicon compound thin film having durability with a favorable film thickness continuously and efficiently, and thus the present invention is useful for forming an antifouling film which presents stains by fingerprints, sebum, sweat, etc. to a substrate such as display glass, optical elements, hygienic instruments, etc.

This application is a continuation of PCT Application No. PCT/JP2013/054222 filed on Feb. 20, 2013, which is based upon and claims the benefit of priority from Japanese Patent Application No. 2012-037970 filed on Feb. 23, 2012. The contents of those applications are incorporated herein by reference in their entireties.

### REFERENCE SYMBOLS

11: Chamber
12: Fluorinated organosilicon compound
13: Heating container
15: Nozzle
17: Substrate
18: Substrate transport mechanism
19: Valve
20: Substrate sensor

What is claimed is:

1. An apparatus for producing a fluorinated organosilicon compound thin film for forming a fluorinated organosilicon compound thin film on a substrate surface, which comprises:
a chamber,
a heating container for heating a fluorinated organosilicon compound,
a plurality of nozzles for supplying the fluorinated organosilicon compound to a substrate, provided in the chamber and connected to the heating container, and
a substrate transport mechanism for transporting the substrate so that the plurality of nozzles and a surface of the substrate on which a thin film is to be formed face each other,
wherein the plurality of nozzles are arranged in a line so that they cross the direction of transport of the substrate by the substrate transport mechanism, and
the fluorinated organosilicon compound is one subjected to a solvent removal treatment or one not diluted with a solvent.

2. The apparatus for producing a fluorinated organosilicon compound thin film according to claim 1, wherein among the plurality of nozzles, a nozzle supplying the fluorinated organosilicon compound to the substrate can be selected.

3. The apparatus for producing a fluorinated organosilicon compound thin film according to claim 1, which comprises:
a substrate sensor detecting passage of the substrate, provided on the upstream of the plurality of nozzles in a substrate transport path, and
a valve provided on a fluorinated organosilicon compound supply path connecting the plurality of nozzles and the heating container,
wherein the valve is closed when the substrate sensor detects absence of passage of the substrate for a certain time, and the valve is opened when the substrate sensor detects passage of the substrate again.

4. A process for producing a fluorinated organosilicon compound thin film by forming a fluorinated organosilicon compound thin film on a substrate surface, which comprises:
heating a fluorinated organosilicon compound subjected to a solvent removal treatment or a fluorinated organosilicon compound not diluted with a solvent, in a heating container,
supplying the fluorinated organosilicon compound from a plurality of nozzles arranged in a line so that they cross the direction of transport of a substrate, provided in a chamber and connected to the heating container, and
forming a fluorinated organosilicon compound thin film on a surface of the substrate on which a thin film is to be formed, while the substrate is transported by a substrate transport mechanism so that the plurality of nozzles and the surface of the substrate on which a thin film is to be formed face each other.

5. The process for producing a fluorinated organosilicon compound thin film according to claim 4, wherein among the plurality of nozzles, a nozzle supplying the fluorinated organosilicon compound to the substrate can be selected.

6. The process for producing a fluorinated organosilicon compound thin film according to claim 4, wherein a substrate sensor detecting passage of the substrate, provided on the upstream of the plurality of nozzles in a substrate transport path; and a valve provided on a fluorinated organosilicon compound supply path connecting the plurality of nozzles and the heating container; are provided, and the valve is closed when the substrate sensor detects absence of passage of the substrate for a certain time, and the valve is opened when the substrate sensor detects passage of the substrate again.

7. The process for producing a fluorinated organosilicon compound thin film according to claim 4, wherein the fluorinated organosilicon compound is a fluorinated organosilicon compound having at least one group selected from the group consisting of a perfluoropolyether group, a perfluoroalkylene group and a perfluoroalkyl group.
